(19) United States
(12) Patent Application Publication
(10) Pub. No.: US 2024/0289708 A1
(43) Pub. Date: Aug. 29, 2024

(54) MONITORING AND ALERTING SYSTEM AND METHOD

(71) Applicant: BREAD FINANCIAL PAYMENTS, INC., Columbus, OH (US)

(72) Inventors: Yi CHENG, Katy, TX (US); Wes HUNT, Hilliard, OH (US); Dianne KREMER, Westerville, OH (US); Darrin VIA, Pickerington, OH (US)

(73) Assignee: BREAD FINANCIAL PAYMENTS, INC., Columbus, OH (US)

(21) Appl. No.: 18/447,266

(22) Filed: Aug. 9, 2023

Related U.S. Application Data
(60) Provisional application No. 63/487,251, filed on Feb. 27, 2023.

(51) Int. Cl. G06Q 10/0631; G06Q 10/0639

(52) U.S. Cl. CPC G06Q 10/063114; G06Q 10/06393

(57) ABSTRACT

A system and method for monitoring a process is disclosed. The system selects at least one process, identifies a plurality of metrics for the at least one process and automatically develop a performance envelope for at least one of the plurality of metrics. The data related to the at least one process is continually monitored, in real-time, for any data related to the plurality of metrics. Any data related to the plurality of metrics is automatically stored in an alert database and automatically analyzed for any data points outside of the performance envelope. An alert is automatically generated for one or more identified data points. A response is received for each of the identified data points and the identified data points are updated in the alert database with the response.

### CROSS-REFERENCE TO RELATED APPLICATIONS (PROVISIONAL)

This application claims priority to and benefit of co-pending U.S. Provisional Patent Application No. 63/487,251, filed on Feb. 27, 2023, entitled “MONITORING AND ALERTING SYSTEM AND METHOD” by Wes Hunt et al., and assigned to the assignee of the present application, the disclosure of which is hereby incorporated herein by reference in its entirety.

### BACKGROUND

Presently, reporting and alerting solutions require consumers to provide thresholds that are used to identify whether a given metric value is good or bad. However, in order to establish the thresholds, a certain level of knowledge about one or more aspects of the given metric being measured is required. While the ability to derive and understand information for a given metric might be known and/or learned/obtained by one of skill, this ability is only finitely scalable.

Once the user's threshold to derive and understand information for one or more metrics is reached, that user would not be able to derive, understand, evaluate, and/or keep up with additional metrics, such as multiple potential breakpoints, data that follows different patterns, and the like. That is, a person's ability is not infinite, instead, they are only capable of obtaining, retaining, monitoring, or otherwise working with a limited number of metrics, breakpoints, etc. Moreover, even when operating within a person's capabilities, human error(s) can result in missed opportunity for sales, profits, extra operating cost, financial penalties, and the like. In some cases, these are incurred when the user fails to capture, identify, and/or otherwise timely act upon one or more identifiably available aspects within the monitored metrics.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a method for business monitoring and alerting, in accordance with an embodiment.

FIG. 2 is a flow diagram for data and statistical processing, in accordance with an embodiment.

FIG. 3 is a flowchart of a method for process control method calculation, in accordance with an embodiment.

FIG. 4A is a flow diagram for alert tracking issue and remediation, in accordance with an embodiment.

FIG. 4B is a block diagram of two alert paths for providing an alert with a root cause analysis (RCA), in accordance with an embodiment.

FIG. 4C is a flow diagram of an issue, status change, and resolution tracking solution, in accordance with an embodiment.

FIG. 5 is a block diagram of an example process broken down into a plurality of process steps each with one or more associated metrics, in accordance with an embodiment.

FIG. 6 is a screen capture of an example dashboard displayed on a graphical user interface (GUI), in accordance with an embodiment.

FIG. 7 is a two graph comparison of an example process with the same metric and same channel for different brands, in accordance with an embodiment.

FIG. 8 is a two graph comparison of an example process with the same metric and same brand for different channels, in accordance with an embodiment.

FIG. 9 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “deciding”, “determining”, “interacting”, “searching”, “pinging” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

In the following discussion, a number of block diagrams, flow diagrams, flowcharts, graphs, steps, inputs, outputs, procedures, and/or components and the like are disclosed. However, it should be appreciated that in other embodiments one or more of the steps, inputs, outputs, procedures, and/or components of one or more of the block diagrams, flow diagrams, flowcharts, graphs, computer systems, graphical user interface (GUI) diagrams, and the like could be added, skipped, performed in a different order, or the like. Moreover, in one embodiment, some or all of the inputs and/or outputs that are shown in one or more Figures could be substituted with other steps, inputs, outputs, procedures, and/or components such as, but not limited to, those shown in the other Figures and/or their equivalents.

The term “client” refers to a retailer, brand, business, IT department, IT manager, customer, manager, combination thereof, or the like, that would utilize the monitoring and alerting system for one or more of their own processes.

The term “performance envelope” refers to one or more automatically and dynamically developed thresholds, value ranges, or the like for actual (and/or expected) activities, usage, results, queries, and/or the like. In general, the performance envelope can differ (and or be established with different parameters) per client and/or per process. In one embodiment, the performance envelope for one or more metrics is made automatically calculated by the monitoring system. In one embodiment, the performance envelope for one or more metrics includes criteria provided by a client in place of (or in addition to) the value automatically calculated by the monitoring system.

### Overview

The following discussion provides a novel agnostic monitoring and alerting system and method. In one embodiment, the system monitors one or more processes and their underlying metrics. In general, the tool will analyze data related to the one or more processes and their underlying business metrics and provide real-time or near real-time user digestible information based on the results of the analysis. Embodiments of the solution described herein are able to connect to data either in process core systems or any data storage. Embodiments can transform the data and apply a methodology to provide normal thresholds for each distinct combinations. Embodiments can generate alerts that can be consumed either from direct messages (e.g., emails, texts, etc.) or a common portal (e.g., a dashboard or the like). Embodiments can also track (and/or update the stored data, one or more thresholds, a problem occurring for a given process that should be fixed across other clients using the same process even before the other clients have had an event, etc.) any actions taken after the information/alert has been provided in the user digestible format.

### Operation

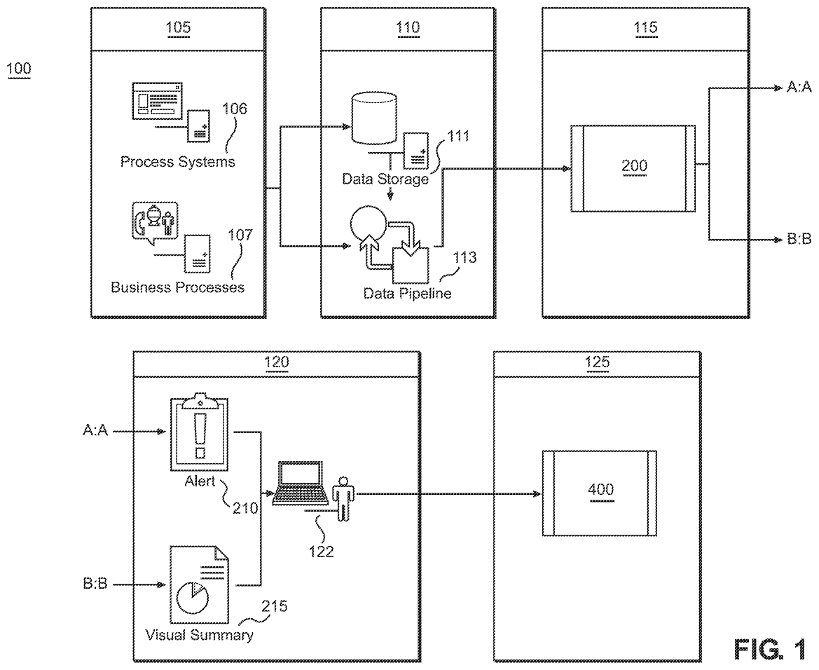

Referring now to FIG. 1, a block diagram 100 of a method for business monitoring and alerting is shown in accordance with an embodiment. Although block diagram 100 illustrates at least one embodiment, it should be appreciated that in other embodiments, steps, inputs, outputs, procedures, and/or components of block diagram 100 could be added, skipped, performed in a different order, or the like.

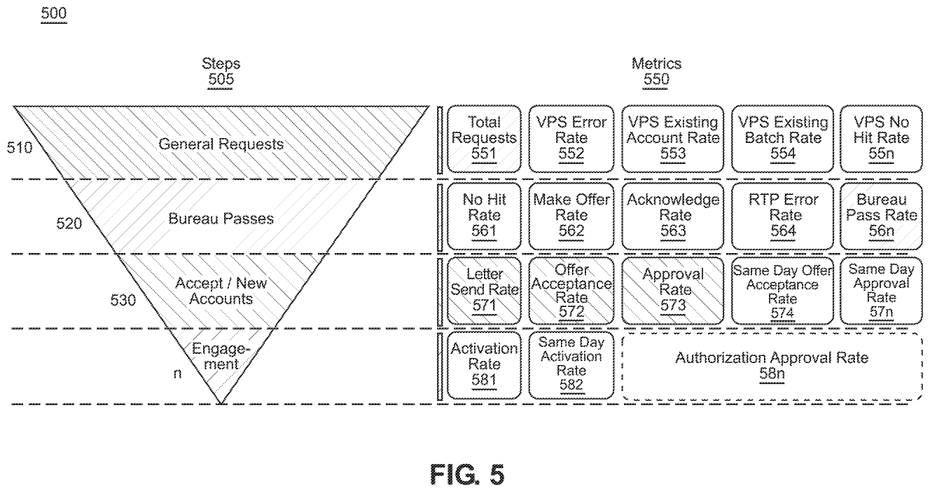

At 105, in one embodiment, any process metrics (and/or business key performance indicators (KPIs)) to be monitored are selected. In one embodiment, the monitored process metrics would include process systems 106 and business processes 107. For example, with reference now to now to FIG. 5, a block diagram of a process 500 broken down into a plurality of process steps 505 each with one or more associated metrics 550 is shown in accordance with an embodiment. The following example uses the process steps 505 and metrics 550 monitored for a real time prescreen (RTP) process 500.

Although FIG. 5 illustrates an RTP process 500 with a provided number of process steps 505 and the metrics 550 for each of those process steps, it should be appreciated that in other embodiments, there may be more, fewer, or different process steps 505 and/or metrics 550 than shown in process 500. Although one process is shown, it should be appreciated that the system is able to monitor more than one process and be applied to multiple processes. However, the embodiment shown in FIG. 5 utilizes one process and its associated breakdown of process steps 505 and metrics 550 for purposes of clarity.

In one embodiment, the process steps 505 can include aspects such as, but not limited to, general requests 510, bureau passes 520, accepts/new accounts 530, engagements n, and the like.

In one embodiment, each of the process steps 505 will include one or more metrics 550. For example, general requests 510 may include metrics such as, but not limited to, total requests 551, virtual profiling system (VPS) error rate 552, VPS existing account rate 553, VPS existing batch rate 554, VPS no hit rate 55n, and the like.

In one embodiment, bureau passes 520 may include metrics such as, but not limited to, no hit rate 561, make offer rate 562, acknowledge rate 563, RTP error rate 564, bureau pass rate 56n, and the like.

In one embodiment, accepts/new accounts 530 may include metrics such as, but not limited to, letter send rate 571, offer acceptance rate 572, approval rate 573, same day offer acceptance rate 574, same day approval rate 57n, and the like.

In one embodiment, engagements n may include metrics such as, but not limited to, activation rate 581, same day activation rate 582, authorization approval rate 58n, and the like.

In one embodiment, one or more of the metrics 550 will include a performance envelope with a upper control limit (UCL). For example, the performance envelope for offer acceptance rate 572 would have a UCL of 25%. As the offer acceptance rate 572 metric is monitored, as long as the offer acceptance rate remained below 25% the data would be evaluated and no alert would be generated. In contrast, if the offer acceptance rate increased past 25%(e.g., 30%), the monitoring system would generate an alert (as described in detail herein).

In one embodiment, one or more of the metrics 550 will include a performance envelope with a UCL and a lower control limit (LCL). For example, the bureau pass rate 560 metric would have an LCL of 10% and a UCL of 30%. As the bureau pass rate 560 metric was monitored, as long as the bureau pass rate remained above 10% and below 30% the data would be evaluated and no alert would be generated. In contrast, if the bureau pass rate dropped below 10%(e.g., 5%) or increased past 30%(e.g., 40%), the monitoring system would generate an alert (as described in detail herein).

Although a performance envelope with a UCL and/or LCL is discussed, it should be appreciated that the performance envelope can also include one, or a range of time periods. For example, a UCL of 30% for a given 24 hour period, week, month, year, etc. Moreover, in another embodiment, the performance envelope can also include different boundary values over a range of time periods. For example, a UCL of 30% for a given 24 hour period, a UCL of 28% for a week, a UCL of 35% for a month, a UCL of 40% for a year, etc.

In one embodiment, the monitoring system will automatically monitor the data for the metric and automatically evaluate that data in light of the performance envelope for the metric. In one embodiment, all of the metrics 550 will include a performance envelope.

In one embodiment, the performance envelope for one or more metrics 550 are made up of one or a plurality of values automatically calculated by the monitoring system based on the unique combinations (such as process, metric, client, etc.). In one embodiment, the performance envelope for one or more metrics 550 includes criteria provided by a client in place of (or in addition to) the automatically calculated value generated by the monitoring system.

In one embodiment, all of the metrics 550 may be monitored and associated with a performance envelope, such that when a metric's activity falls outside of the performance envelope an alert is generated in real-time or near real-time.

In one embodiment, all of the metrics 550 may be monitored and some of the metrics 550 may include a performance envelope, such that when a metric's activity falls outside of the performance envelope an alert is generated in real-time or near real-time.

In one embodiment, some of the metrics 550 may be monitored and associated with a performance envelope, such that when a metric's activity falls outside of the performance envelope an alert is generated in real-time or near real-time.

In one embodiment, some of the metrics 550 may be monitored and some of the metrics 550 being monitored may include a performance envelope, such that when a metric's activity falls outside of the performance envelope an alert an alert is generated in real-time or near real-time.

For purposes of clarity, in one embodiment, the metrics 550 that are identified (selected, ranked, or the like) as metrics 550 are shown in bold. For example, the bold metrics may be more critical/important/or otherwise valued by the process. In one embodiment, if there is a limited capacity to watch the entire system, the bold metrics will be prioritized. In block diagram 500 the critical/important and/or otherwise identified metrics include, e.g., total requests 551, bureau pass rate 56n, letter sent rate 571, offer acceptance rate 572, approval rate 573, and activation rate 581. In another embodiment, more, fewer, and/or different metrics may be identified.

In one embodiment, one, some, or all of the monitored metrics 550 will have an associated performance envelope, such that when the metric's activity falls outside of the performance envelope an alert is generated in real-time or near real-time.

In one embodiment, the selected metrics 550 being monitored are selected, ranked, or the like, by default. In one embodiment, any metric associated performance envelope, are automatically selected by the system. In one embodiment, the selected metrics 550 being monitored are selected, ranked, or the like by the client. In one embodiment, any metric associated with the performance envelope are selected by the client.

Thus, as is clear from the block diagram 500, the number of process steps 505 and their associated metrics 550 for each of the processes, would be quickly overwhelming to a human being. Even the most skilled human would not be able to sift through the data to monitor the process(es) and their metric(s) once the list became more than two or three deep. Moreover, a human would not be able to keep up with the amount of data to provide that monitoring anywhere near real time. Thus, while real-time or near real-time monitoring and alerting is disclosed herein, it is not possible for a human to perform this work. The amount of data being analyzed would quickly overwhelm a human brain and alerts would be found much later (e.g., hours, days, weeks, etc.) due to the need for sleep, bathroom breaks, meals, etc. In many cases, the delay between the out of metric event occurring and when the alert is provided can be linear and even exponential in the scope of damage incurred. As such, a delay between the event's occurrence and the identification of the event, can easily allow one or more the errant processes to grow out of hand and deleteriously effect one or more client. In general, those effects could be financial, penal, reputational, and the like.

With reference again to 105 of FIG. 1, in one embodiment, any data related to the operations of monitored RTP process 500 is generated from the operation of the process systems 106 and/or business processes 107.

At 110, the data related to the operations of the automatically monitored RTP process 500 (which may in one embodiment include process metrics, KPI data, and/or the like) is automatically obtained from one or more data pipeline(s) 113 and stored in data storage 111 (e.g., one or more local, remote, hybrid, or the like, data storage devices). In one embodiment, the data is obtained from the one or more data pipeline(s) 113 using a method such as extract, transform, and load (ETL), or the like.

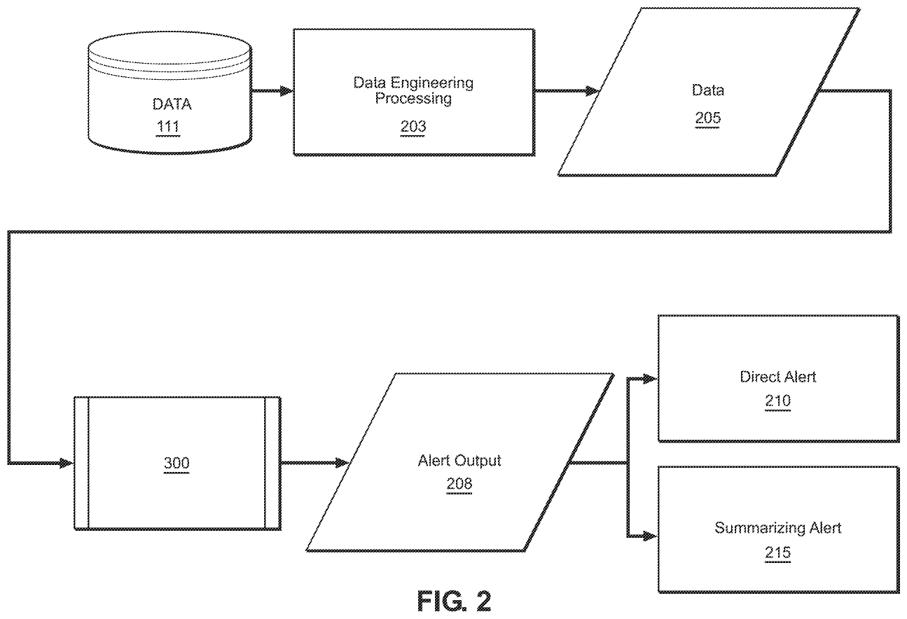

At 115, one embodiment applies the established (e.g., desired, selected, or the like) algorithms and/or models, as shown in further detail in flow diagram 200 of FIG. 2.

With reference now to FIG. 2, a flow diagram 200 for data and statistical processing is shown in accordance with an embodiment. Although flow diagram 200 illustrates at least one embodiment, it should be appreciated that in other embodiments, steps, inputs, outputs, procedures, and/or components shown in flow diagram 200 could be added, skipped, performed in a different order, or the like.

In one embodiment, flow diagram 200 begins by accessing data stored in database 111. The data from database 111 is obtained and evaluated by data engineering processing 203. The results of the evaluation by data engineering processing 203 is then output as data 205 which can include some, most, or all of the processes and metrics over some, most, or all potential breakpoints and/or breakpoint combinations.

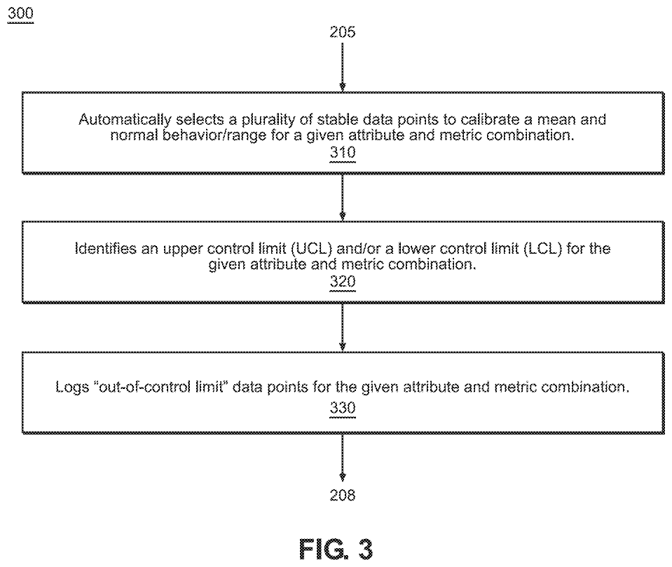

The statistical process control method calculator (as shown by flowchart 300 of FIG. 3) receives data 205 that includes some, most, or all of the processes and metrics over some, most, or all potential breakpoints and/or breakpoint combinations and performs one or more statistical process control method calculations thereon.

With reference now to FIG. 3, a flowchart 300 of a method for process control method calculation is shown in accordance with an embodiment. Although flowchart 300 illustrates at least one embodiment, it should be appreciated that in other embodiments, steps, inputs, outputs, procedures, and/or components of flowchart 300 could be added, skipped, performed in a different order, or the like.

In one embodiment, flowchart 300 begins when the statistical process control method calculator receives data 205 including some, most, or all of the processes and metrics over some, most, or all potential breakpoints and/or breakpoint combinations.

At 310, one embodiment automatically picks a plurality of stable data points to calibrate the mean and a normal behavior/range for a given process and metric combination. In other words, instead of looking at data in a past fixed period as is generally done in a prior art statistical analysis, the statistical process control method calculator picks the most stable points to calibrate the mean and normal behavior/range, in real time. Moreover, by using the real-time data, the statistical process control method calculator is able to define a desired trend of a given combination.

For example, the bureau pass rate 560 metric would have a normal operating range of 15%-25%. However, the statistical process control method calculator would rightly operate with an understanding that when it comes to the offer acceptance rate-higher is better. As such, the calibration method will look for a stable high performing period to calibrate the normal behavior/range.

In contrast, the statistical process control method calculator would rightly operate with an understanding that when it comes to the letter send rate, the lower the better, so the calibration method looks for a stable low performing period to calibrate the normal behavior/range.

In yet another example, e.g., VPS existing account rate, the statistical process control method calculator would rightly operate with an understanding that the VPS existing account rate should be stable over time, e.g., no desired trending is defined. As such, the calibration method will look at the overall stable period and calibrate using those data points.

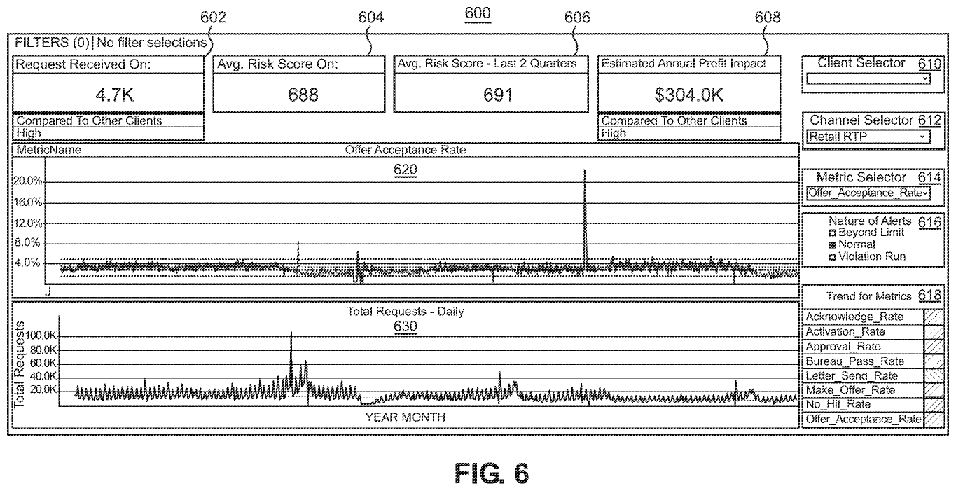

As shown in the graphs of FIGS. 6-8, the stable mean is shown as the center line. It is calculated from the stable calibration period automatically selected by the statistical process control method calculator instead of by default the full dataset to avoid outliers and defects skewing the result.

At 320, one embodiment identifies a UCL and/or LCL for the given process and metric combination. For example, as described herein, the performance envelope calculation automatically determines and generates any limits for a process and metric combination. In general, the standard deviation (sigma) is used to define the UCL and/or LCL. For example, the statistical process control method calculator calculates sigma from the automatically selected stable calibration period.

In one embodiment, the UCL is defined as the mean +3 times sigma. In contrast, the LCL is defined as the mean-3 times sigma. However, it should be appreciated that in another embodiment, either or both the UCL and the LCL could be determined based on a different number of sigmas.

For example, the bureau pass rate 560 metric would have an LCL of 10% and a UCL of 30%. If the connection with the bureau was down, the monitoring system would identify the data for the bureau pass rate metric indicated a drop to below 10% and an alert would be generated.

At 330, one embodiment logs any “out-of-control limit” data points for the given process and metric combination. In one embodiment, the information obtained by the performance of the process control method calculation shown in Flowchart 300 is passed to alert output 208 of FIG. 2.

Continuing with the bureau pass rate example, in one embodiment, the alert would be output as either the direct alert 210 and/or the summarizing alert 215. In one embodiment, the threshold for sending the direct alert 210 and the summarizing alert 215 would be the same value (e.g., LCL of 10% and a UCL of 30%).

In one embodiment, the threshold for sending the summarizing alert 215 would be a first value (e.g., LCL of 10% and a UCL of 30%) and the threshold for sending the direct alert 210 would be a second value (e.g., LCL of 5% and a UCL of 35%). For example, in one embodiment, the direct alert 210 would be used when a significant departure from the performance envelope is detected and personnel would need to respond immediately, while the summarizing alert 215 would be sent out earlier in the departure from the performance envelope, before the event reached the direct alert 210 bounds and the personnel who are on the direct alert 210 would not necessarily need to be interrupted. Although a change in the range of 5% is provided in one embodiment for purposes of clarity, it should be appreciated that another embodiment may utilize a different change (to one or both ends of the range) of more or less than 5% for the second value.

In one embodiment, the threshold for sending the summarizing alert 215 would be a first time frame (e.g., when the departure from the performance envelope occurs or is identified) and the threshold for sending the direct alert 210 would be a second time frame (e.g., 15 minutes after the summarizing alert 215 has been sent) if no remediation or action has been taken with respect to the alert. Although a time of 15 minutes is provided in one embodiment for purposes of clarity, it should be appreciated that another embodiment may utilize a different time period of more or less time than 15 minutes.

Referring again to FIG. 2, the information obtained by the performance of the process control method calculation shown in Flowchart 300 is passed to alert output 208 which includes aspects such as, but not limited to, the list of potential issues identified by the process control method calculations of FIG. 3.

In one embodiment, the information obtained by alert output 208 is then output as one or both of a direct alert 210 or a summarized alert 215. In one embodiment, direct alert 210 is a real-time alert that will provide an (automated and/or curated) email, text, message, or other pop-up type alert directly to a client or a designated user or users (e.g., process manager, owner, designated IT personnel, or the like). In one embodiment, summarized alert 215 is an alert that would be presented on a visual dashboard such as shown in FIG. 6.

With reference again to FIG. 1, at 120, one embodiment provides the output for actions. In one embodiment, the output for action can include an alert 210 and/or a visual summary 215 as described in detail herein. In one embodiment, the alert 210 and/or visual summary 215 is then presented to the owner/IT provider/manager 122 for the issues that have been identified.

At 125, one embodiment tracks the actions.

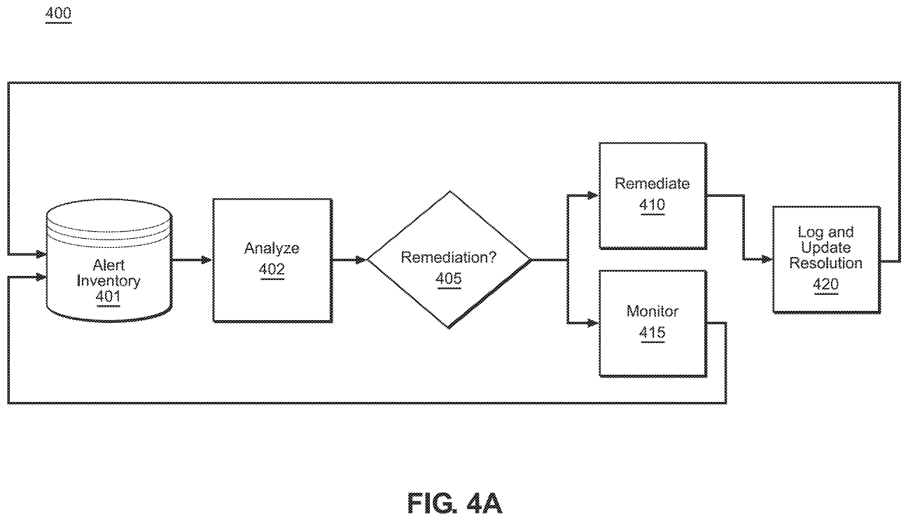

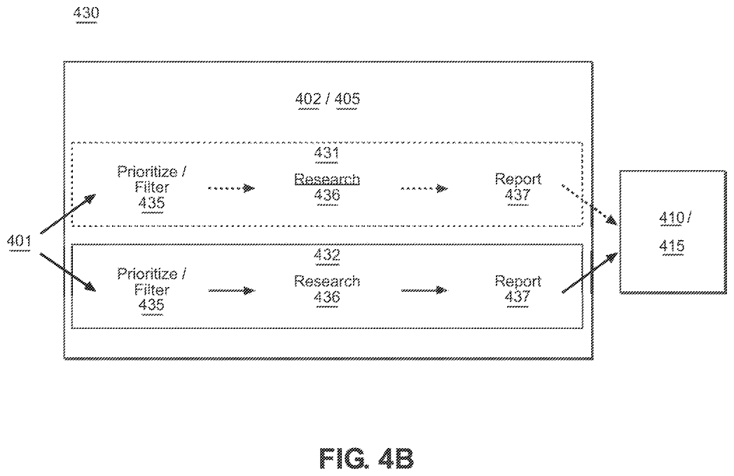

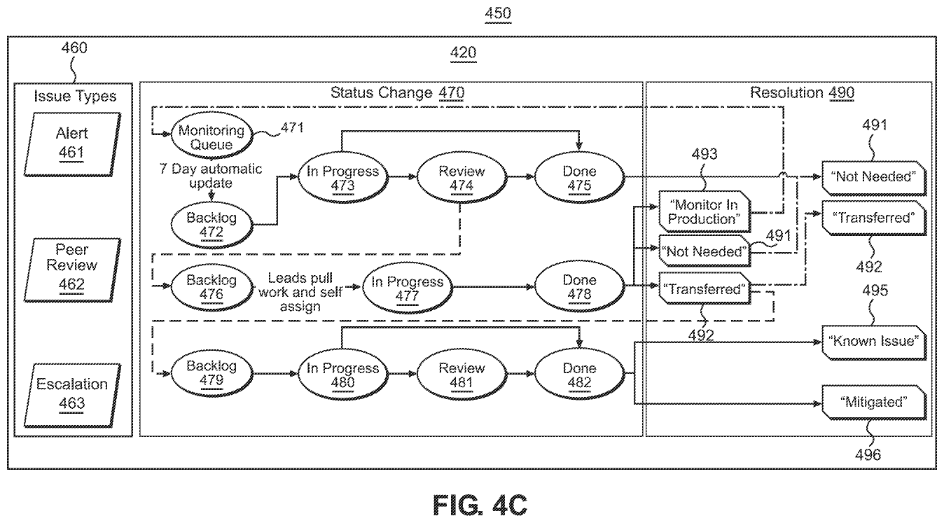

With reference now to FIG. 4A, a flow diagram 400 for alert tracking issue and remediation is shown in accordance with an embodiment. Although flow diagram 400 illustrates at least one embodiment, it should be appreciated that in other embodiments, steps, inputs, outputs, procedures, and/or components shown in flow diagram 400 could be added, skipped, performed in a different order, or the like.

In one embodiment, flow diagram 400 begins by analyzing the alert inventory database 401 which includes all of the alerts provided to alert output 208.

At 402, the alerts are analyzed. At 405, the analysis determines if any remediation should be performed. If the analysis at 405 determines no remediation is performed (or if it is determined that no remediation needs to be performed), at 415 the process continues monitoring and loops back to the alert inventory database 401. As such, the alert tracking for issues and remediation is continually looking at any new data received at the alert inventory database 401.

In one embodiment, if the analysis at 405 determines remediation should be performed, at 410 the remediation is performed. At 420, the data identifying the resolution based on the remediation is logged, updated, or the like. In one embodiment, the process then loops back to the alert inventory database 401 where the remediation is logged, updated, or the like at alert inventory database 401. As such, the alert tracking for issues and remediation is continually looking at any new data received at the alert inventory database 401.

With reference now to FIG. 4B, a block diagram 430 of two alert paths providing an alert with an RCA is shown in accordance with an embodiment. Although flow diagram 430 illustrates at least one embodiment, it should be appreciated that in other embodiments, steps, inputs, outputs, procedures, and/or components shown in block diagram 430 could be added, skipped, performed in a different order, or the like.

In general, the alert paths shown in FIG. 4B expand upon the analysis boxes 402 and 405 of FIG. 4A. In general, the analysis and remediation determination of the data from the alert inventory database 401 will follow the self-service RCA path 431, a managed RCA path 432, and/or a hybrid path that includes both the self-service RCA path 431 and the managed RCA path 432.

For example, the client can use the self-service RCA path 431 to ensure their own personal are responding to and remediating an alert. In one embodiment, the client can use the managed RCA path 432 thereby allowing the provider to respond to and remediate an alert. In one embodiment, the client can use the hybrid path (e.g., the self-service RCA path 431 and the managed RCA path 432) allowing the client's personnel to respond to and remediate an alert, where the client's personnel are supported by the provider that is also able to respond to and remediate an alert if the client has not responded and/or remediated in a given time frame, has asked for assistance, has selected the managed RCA path 432 for a given alert, etc.

In one embodiment, the self-service RCA path 431 and the managed RCA path 432 (which could also therefore include the hybrid path) would include a prioritize/filter 435 component to filter and or prioritize the data from the alert inventory database 401. In general, the filter feature would remove data from the alert inventory database 401 that was not subject to an alert, further analysis, or the like. In one embodiment, the prioritization feature would prioritize the data from the alert inventory database 401 based on predefined ranking of alerts. In another embodiment, instead of prioritizing the data from the alert inventory database 401 based on predefined ranking, the prioritize/filter 435 component will calculate the potential impact of each alert to prioritize and rank the alerts.

For example, to calculate the potential impact of a letter send rate alert, the system calculates the difference between the normal expected letter send volume and the actual out of control limit letter send volume. The resultant difference is then multiplied by the per letter cost to provide an assessment of this alert's impact which is then used for ranking and/or prioritizing the letter send rate alert.

In one embodiment, the self-service RCA path 431 and the managed RCA path 432 (which could also therefore include the hybrid path) include a research 436 feature used to research any data that has successfully passed through the prioritize/filter 435 component.

In one embodiment, the self-service RCA path 431 and the managed RCA path 432 (which could also therefore include the hybrid path) include a report 437 feature to generate a report. In one embodiment, the report includes all the data that has successfully passed through the prioritize/filter 435 component as well as any research found by the research 436 feature.

In one embodiment, after the report is generated by report 437, the self-service RCA path 431 and the managed RCA path 432 (which could also therefore include the hybrid path) are completed (e.g., the analysis 402 and remediate 405 of FIG. 4A), the process returns to either 410 or 415 of FIG. 4A.

Using the bureau pass rate 560 metric example, having an LCL of 10% and a UCL of 30%. when the connection with the bureau is down, the monitoring system would identify the data for the bureau pass rate metric indicated a drop to below 10% and an alert would be generated. The alert from the alert inventory 401 would be provided to the self-service RCA path 431 and the managed RCA path 432 (which could also therefore include the hybrid path). The remediation would be the solution to the alert. For example, once it is recognized that the bureau pass rate 560 had dropped below the 10%, the alert would cause the system (or client) to research the problem. In one embodiment, the system would determine the issue and provide the report. E.g., there is an error in the credit underwriting rules installed in the credit bureau process, etc. The remediation 410 would then be to use a backup bureau or another system to perform any bureau related process while the connection remains disrupted.

In one embodiment, once the remediation is identified and/or performed, the solution would be logged and updated 420 in the alert inventory database 401.

In one embodiment, the report could indicate the scope of the alert. For example, in a client specific matter, (e.g., a lack of mailers on a given day due to a local printshop issue) the report would be logged with the specific alert for the client and no further actions would be needed. In contrast, if the report indicated an issue that would likely affect multiple clients (e.g., there is an error in the credit underwriting rules installed in the credit bureau process, etc.) and the resolution (e.g., to use a backup bureau or quasi-bureau) could be provided to other clients before their own system even fell below the performance envelope criteria. Thus, the alert and resolution could be local, the alert and resolution could be global, or somewhere in between.

With reference now to FIG. 4C, a flow diagram 450 of an expanded process 420 for issue 460, status change 470, and resolution 490 tracking solution is shown in accordance with an embodiment. Although the flow diagram 450 illustrates at least one embodiment, it should be appreciated that in other embodiments, steps, inputs, outputs, procedures, and/or components shown in the flow diagram could be added, added, skipped, performed in a different order, or the like.

In one embodiment, issue 460 includes issue types such as alert 461, peer review 462, escalation 463, and the like.

In one embodiment, the alert logging process 420 starts with creating alert ticket. (Issue type=task type). It first sits in the backlog and once it starts being worked on, the status becomes in progress.

In one embodiment, status change 470 provides a flow path for moving between the issue types. For example, at the alert 461 level, the flow includes monitoring queue 471 (discussed herein) and backlog 472 (which may in one embodiment include an automatic update time frame between monitoring queue 471), in progress 473, and then review 474. The result of review 474 will either result in the path of done 475 where the path moves to resolution 490 and not needed 491, or the path the status change level peer review 462 as it moves to backlog 476, then to in progress 477, and to done 478. At that time, the path moves again into resolution 490 where the options are, in one embodiment, monitor in production 493, not needed 491, and transferred 492.

In one embodiment, monitoring queue 471 is used when the peer review results in a solution to continue monitoring the situation for longer period. In so doing, the ticket will be automatically added to the monitoring queue to sit for a period to continue collecting more data, until it gets automatically transferred again to backlog to be further analyzed.

If the event moves along the path of monitor in production 493 the process will return to monitoring queue 471.

If the event moves along the path of not needed 491 the process will be complete.

If the event moves along the path of transferred 492 the process will then move to the escalation 463 level where it will move again to another backlog 479, then to in progress 480, review 481, and done 482. In one embodiment, when it is moved to another backlog 479, a new escalation ticket will be created in the backlog status. At that time, the path moves again into resolution 490 where the options are, in one embodiment, known issue 495 and mitigated 496.

With reference now to FIG. 6, a screen capture of an example dashboard 600 displayed on a GUI is shown in accordance with an embodiment. Although dashboard 600 illustrates at least one embodiment, it should be appreciated that in other embodiments, there may be more or fewer processes, graphs, features, and/or metrics than shown in dashboard 600. In one embodiment, the aspects of dashboard 600 may be modified and/or replaced with different aspects, time ranges, values, and the like, for one or more different clients. In one embodiment, the modifications may be made by the client. In one embodiment, the modification may be based on different valuation of one or more processes, graphs, features, and/or metrics for one or more clients.

In one embodiment, clicking on (and/or mousing over, or otherwise selecting) any of the different data boxes, graph(s), or the like may cause the selected feature to open in a new window (or tab, etc.), may cause information about the selected feature to be provided in the data boxes (or in new data boxes), may cause any alerts (including remediations, etc.) related to the selected feature to be shown, etc. In other words, one or more of the features of dashboard 600 can be shown by default, preference, a combination thereof, and when selected or otherwise interacted with, one or more of those features displayed on dashboard 600 will open up a deeper dive into the information as discussed herein. Thus, the dashboard 600 can be used as a managerial tool (e.g., high granular view) as well as an in the trenches type tool that provides increased levels of granularity for a client looking into the details, e.g., looking at a specific event for a specific metric and the data (including the actual data, any errors, alerts, remediations, and the like) associated therewith.

In one embodiment, dashboard 600 includes a client selector 610, a channel selector 612 (e.g., a process), and a metric selector 614 set of drop down menus. In one embodiment, for example when the dashboard 600 is being used by a client there may not be a client selector 610 option as the client would only have access to their information.

In one embodiment, dashboard 600 includes a trend for metrics 618 data block showing a plurality of the metrics for a process selected in channel selector 612, for a plurality of metrics for a plurality processes, or the like.

In one embodiment, dashboard 600 includes graph 620 and 630 which provide a visual representation of the performance of a selected metric over a selected time period. In one embodiment, one or both of graphs 620 and 630 may be interactive such that they can be zoomed in/out on, axis values changed, and the like.

and a nature of alerts key 616. In general, the nature of alerts key 616 is related to the graph(s) 620 and 630 and provides color visual interpretation to allow a user to quickly obtain outlying information from the graph even at a high level overview.

In one embodiment, dashboard 600 can include other blocks of data such as blocks 602-608. In general, the data within blocks 602-608 may be the most important metrics as selected by default, by a client, by a hybrid thereof, or the like. Although a number of data blocks are shown in dashboard 600, it should be appreciated that other embodiments may include more, fewer, and/or different data blocks. In one embodiment, data block 602 displays a metric of the number of requests received on a given day. In one embodiment, data block 604 displays a metric of the average risk score on a given day. In one embodiment, data block 606 displays a metric of the average risk score for a given time period. In one embodiment, data block 608 displays a metric of the profit impact for a selected time period.

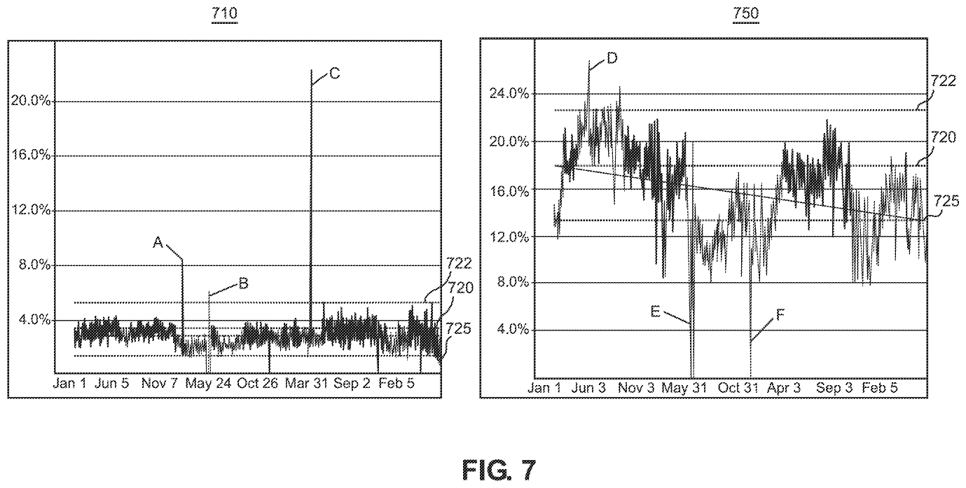

Referring now to FIG. 7, a two graph comparison of an example of the different performance results for different brands (e.g., graph 710 and graph 750), even though they are both using the same process and the same metric, is shown in accordance with an embodiment. In one embodiment, and for purposes of clarity of the example, the two graphs cover the same time frame. In general, RTP has different channels. In the examples of FIG. 7 the same Retail RTP process is shown.

For example with respect to FIG. 7 and the example process discussion of FIG. 5, graph 710 shows an example of the performance data from the same retail RTP process 500 and the “offer acceptance rate” 572 metric for a first client while graph 750 shows an example of the performance data from the same retail RTP process 500 and “offer acceptance rate” 572 metric for a second client. In graphs 710 and 750, the mean 720, UCL 722, and LCL 725 are shown.

As shown by the comparison of graphs 710 and 750, the process performance depicted by graph 710 has beyond limit events A, B, and C while the process performance depicted by graph 750 has beyond limit events D, E, and F. Thus, even though they are for the same time frame, same process, and same metric the performance may or may not be different for the different client, and in this example, they do have different performance characteristics. That is, graph 710 has the performance envelope calibrated (automatically by the solution) as ˜2% to ˜6% while graph 750 has the range as ˜13% to ˜23%.

In general, beyond limit refers to an alert type that denotes data point beyond the control limits (UCL and LCL). Normal refers to data points operating between UCL and LCL and are not “violation run” as defined herein.

In one embodiment, as the metric (e.g., the “offer acceptance rate”) may or may not have different performance results for different clients, the metric monitoring system will automatically establish (or the client may provide) independent performance envelope criteria, even though the same process (e.g., RTP process 500) and metric (e.g., the “offer acceptance rate” 572) is being monitored.

In general, upper specification limit (USL) and lower specification limit (LSL) refer to client or other components specifically providing a use defined threshold, as opposed to the system automatically calculated UCL and LCL.

Although two clients are shown in the present example, it should be appreciated that another embodiment might include any number of clients utilizing the same process and metric where one or more of the different clients will have different performance envelopes.

However, since the system is automatically monitoring the processes, metrics, and automatically and dynamically developing the performance envelope thereof, the system is able to maintain real-time and near real-time monitoring and analysis in situations where a human would quickly fail (e.g., the monitoring of 2, 5, 10, 50, 100, etc. different clients). This further illustrates that a human would be quickly overwhelmed attempting to monitor more than one client even when monitoring the same process and metric due to the different rules, requirements, and operational bounds of the plurality of clients. Therefore, it is impossible for a human to perform the functions described herein.

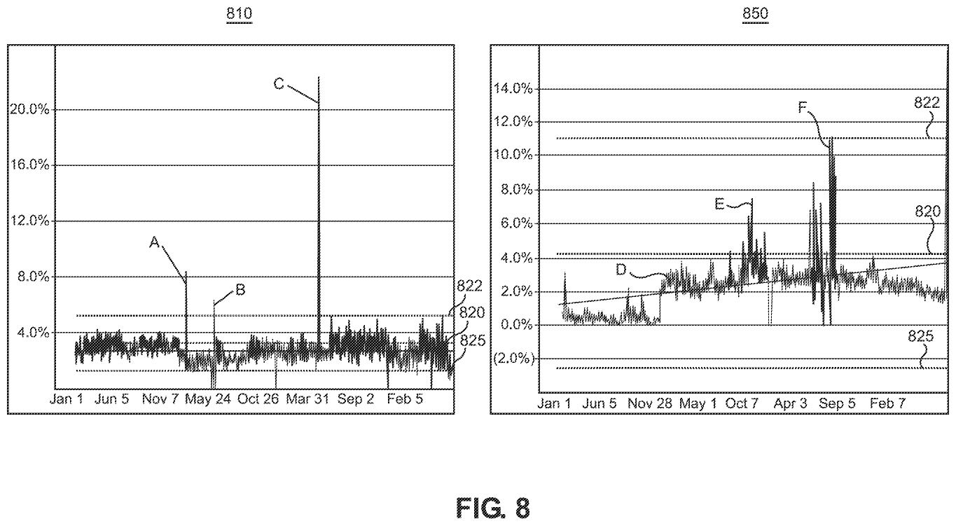

Referring now to FIG. 8, a two graph comparison of an example process with the same client and same metric for different processes (e.g., graph 810 and graph 850) is shown in accordance with an embodiment. In the examples of FIG. 8, the difference of Retail vs Web RTP is shown. In graphs 810 and 850, the mean 820, UCL 822, and LCL 825 are shown.

For example with respect to FIG. 8 and the example process discussion of FIG. 5, graph 810 shows an example of the data from the retail RTP process 500 (associated with the “offer acceptance rate” 572 metric) while graph 850 shows an example of the data from a Web RTP channel process 500 using the same “offer acceptance rate” 572 metric).

As shown by the comparison of graphs 810 and 850, the process of graph 810 has beyond limit events A, B, and C. In contrast, the process of graph 850 has violation run event D and beyond limit events E and F. Thus, even though they are the same metric monitored for the same client over the same time frame, the metric being monitored may or may not perform differently for the different processes, and in this example, they do have different performance characteristics.

In one embodiment, the term “violation run” refers to an alert type that denotes data points displaying a continuously increasing or decreasing trend. An alert is considered a violation run if it satisfies one or more of these seven tests conducted to identify specific cause variations:
Test 1: 8/9 points on the same side of the center line.
Test 2: 6 consecutive points are steadily increasing or decreasing.
Test 3: 14 consecutive points are alternating up and down.
Test 4: 2 out of 3 consecutive points are more than 2 sigma from the center line in the same direction.
Test 5: 4 out of 5 consecutive points are more than 1 sigma from the center line in the same direction.
Test 6: 15 consecutive points are within 1 sigma of the center line.
Test 7: 8 consecutive points are on either side of the center line and not within 1 sigma.

In one embodiment, since the metric (e.g., the “offer acceptance rate”) is expected to have different performance results based on the different processes (e.g., Retail RTP versus Web RTP), the metric monitoring system will establish different performance envelopes for the different processes even though the same metric is being monitored (e.g., the “offer acceptance rate” metric).

Although two process are shown in the present example, it should be appreciated that another embodiment might include any number of processes utilizing the same metric (e.g., the “offer acceptance rate”), wherein one or more of the processes will have different performance envelopes.

Since the system is automatically monitoring the processes, metrics, and automatically and dynamically calculating the performance envelope thereof, the system is able to maintain real-time and near real-time monitoring and analysis in situations where a human would quickly fail. This further illustrates that a human would be quickly overwhelmed attempting to monitor more than one process even when monitoring the same metric for a single client due to the different rules, requirements, and operational bounds of the two processes. Therefore, it is impossible for a human to perform the functions described herein.

### Example Computer System Environment

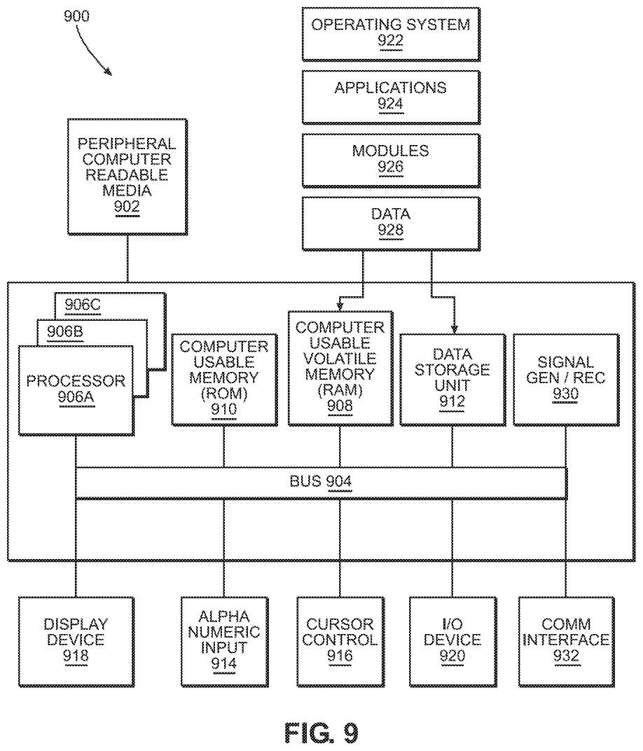

With reference now to FIG. 9, portions of the technology for providing a communication composed of computer-readable and computer-executable instructions that reside, for example, in non-transitory computer-readable medium for storing instructions of a computer system. That is, FIG. 9 illustrates one example of a type of computer that can be used to implement embodiments of the present technology. FIG. 9 represents a system or components that may be used in conjunction with aspects of the present technology. In one embodiment, some or all of the components described herein may be combined with some or all of the components of FIG. 9 to practice the present technology.

FIG. 9 illustrates an example computer system 900 used in accordance with embodiments of the present technology. It is appreciated that system 900 of FIG. 9 is only an example and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 9, computer system 900 of FIG. 9 is well adapted to having peripheral computer readable media 902 such as, for example, an external hard drive, a compact disc, a flash drive, a thumb drive, a wireless radio enabled device, and the like coupled thereto.

Computer system 900 of FIG. 9 includes an address/data/control bus 904 for communicating information, and a processor 906A coupled to bus 904 for processing information and instructions. As depicted in FIG. 9, system 900 is also well suited to a multi-processor environment in which a plurality of processors 906A, 906B, and 906C are present. Conversely, system 900 is also well suited to having a single processor such as, for example, processor 906A. Processors 906A, 906B, and 906C may be any of various types of microprocessors. Computer system 900 also includes data storage features such as a computer usable volatile memory 908, e.g., random access memory (RAM), coupled to bus 904 for storing information and instructions for processors 906A, 906B, and 906C.

System 900 also includes computer usable non-volatile memory 900, e.g., read only memory (ROM), coupled to bus 904 for storing static information and instructions for processors 906A, 906B, and 906C. Also present in system 900 is a data storage unit 902 (e.g., a magnetic disk drive, optical disk drive, solid state drive (SSD), and the like) coupled to bus 904 for storing information and instructions. Computer system 900 also includes an optional alpha-numeric input device 914 including alphanumeric and function keys coupled to bus 904 for communicating information and command selections to processor 906A or processors 906A, 906B, and 906C. Computer system 900 also includes an optional cursor control device 916 coupled to bus 904 for communicating user input information and command selections to processor 906A or processors 906A, 906B, and 906C. Optional cursor control device may be a touch sensor, gesture recognition device, and the like. Computer system 900 of the present embodiment also includes an optional display device 908 coupled to bus 904 for displaying information.

Referring still to FIG. 9, optional display device 908 of FIG. 9 may be a liquid crystal device, cathode ray tube, OLED, plasma display device or other display device suitable for creating graphic images and alpha-numeric characters recognizable to a user. Optional cursor control device 916 allows the computer user to dynamically signal the movement of a visible symbol (cursor) on a display screen of display device 908. Many implementations of cursor control device 916 are known in the art including a trackball, mouse, touch pad, joystick, non-contact input, gesture recognition, voice commands, bio recognition, and the like. In addition, special keys on alpha-numeric input device 914 capable of signaling movement of a given direction or manner of displacement. Alternatively, it will be appreciated that a cursor can be directed and/or activated via input from alpha-numeric input device 914 using special keys and key sequence commands.

Computer system 900 also includes an I/O device 920 for coupling system 900 with external entities. For example, in one embodiment, I/O device 920 is a modem for enabling wired or wireless communications between system 900 and an external network such as, but not limited to, the Internet or intranet. A more detailed discussion of the present technology is found below.

Referring still to FIG. 9, various other components are depicted for system 900. Specifically, when present, an operating system 922, applications 924, modules 926, and data 928 are shown as typically residing in one or some combination of computer usable volatile memory 908, e.g. random-access memory (RAM), and data storage unit 910. However, it is appreciated that in some embodiments, operating system 922 may be stored in other locations such as on a network or on a flash drive; and that further, operating system 922 may be accessed from a remote location via, for example, a coupling to the internet. In one embodiment, the present technology, for example, is stored as an application 924 or module 926 in memory locations within RAM 908 and memory areas within data storage unit 910. The present technology may be applied to one or more elements of described computer system 900.

System 900 also includes one or more signal generating and receiving device(s) 930 coupled with bus 904 for enabling system 900 to interface with other electronic devices and computer systems. Signal generating and receiving device(s) 930 of the present embodiment may include wired serial adaptors, modems, and network adaptors, wireless modems, and wireless network adaptors, and other such communication technology. The signal generating and receiving device(s) 930 may work in conjunction with one or more communication interface(s) 932 for coupling information to and/or from system 900. Communication interface 932 may include a serial port, parallel port, Universal Serial Bus (USB), Ethernet port, Bluetooth, thunderbolt, near field communications port, WiFi, Cellular modem, or other input/output interface. Communication interface 932 may physically, electrically, optically, or wirelessly (e.g., via radio frequency) couple computer system 900 with another device, such as a mobile telephone, radio, or computer system.

The computing system 900 is only one example of a suitable computing environment and is not intended to suggest any limitation as to the scope of use or functionality of the present technology. Neither should the computing environment be interpreted as having any dependency or requirement relating to any one or combination of components illustrated in the example computing system 900.

The present technology may include computer-executable instructions, such as program modules, being executed by a computer. Generally, program modules include routines, programs, objects, components, data structures, etc., that perform particular tasks or implement particular abstract data types. The present technology may also occur in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method comprising:
selecting at least one process;
identifying a plurality of metrics for said at least one process;
automatically calculating a performance envelope for at least one of said plurality of metrics;
continually monitoring, in real-time, data related to said at least one process for any data related to said plurality of metrics;
automatically storing any of said data related to said plurality of metrics in an alert database;
automatically analyzing said stored data for any data points outside of said performance envelope for said at least one of said plurality of metrics;
automatically generating an alert for one or more identified data points;
receiving a response for each of said identified data points; and
updating, in said alert database, said identified data points with said response.

2. The method of claim 1 wherein said plurality of metrics are selected from a group consisting of: system performance metrics, key performance indicators (KPI) metrics, and a combination of said system performance metrics and said KPI metrics.

3. The method of claim 1 wherein said performance envelope comprises:
one or more automatically and dynamically developed thresholds indicative of the end of a range of normal behavior for one or more process attributes selected from a group consisting of: activities, usage, results, and queries.

4. The method of claim 1 wherein said performance envelope comprises:
one or more automatically and dynamically developed value ranges indicative of a normal behavior for one or more process attributes selected from a group consisting of: activities, usage, results, and queries.

5. The method of claim 1 wherein said performance envelope comprises:
one or more automatically and dynamically developed thresholds for one or more process attributes selected from a group consisting of: activities, usage, results, and queries; and
one or more automatically and dynamically developed value ranges for one or more process attributes selected from said group consisting of: activities, usage, results, and queries.

6. The method of claim 1 further comprising:
analyzing said alert for one of said identified data points;
determining if a remediation is needed for said alert based on said analysis of said alert; and
providing, as said response, a no remediation performed message if no remediation is needed.

7. The method of claim 1 further comprising:
analyzing said alert for one of said identified data points;
determining if a remediation is needed for said alert based on said analysis of said alert;
performing said remediation if a remediation is needed; and
providing, as said response, a report of said remediation performed.

8. A non-transitory computer-readable medium for storing instructions, said instructions comprising:
one or more instructions which, when executed by one or more processors, cause one or more processors to:
select at least one process;
identify a plurality of metrics for said at least one process;
automatically calculate a performance envelope for at least one of said plurality of metrics;
continually monitor, in real-time, data related to said at least one process for any data related to said plurality of metrics;
automatically store any of said data related to said plurality of metrics in an alert database;
automatically analyze said stored data for any data points outside of said performance envelope for said at least one of said plurality of metrics;
automatically generate an alert for one or more identified data points;
receive a response for each of said identified data points; and
update, in said alert database, said identified data points with said response.

9. The non-transitory computer-readable medium of claim 8, wherein said plurality of metrics are selected from a group consisting of: system performance metrics, key performance indicators (KPIs) metrics, and a combination of said system performance metrics and said KPI metrics.

10. The non-transitory computer-readable medium of claim 8, wherein said performance envelope comprises:
one or more automatically and dynamically developed thresholds indicative of the end of a range of normal behavior for one or more process attributes selected from a group consisting of: activities, usage, results, and queries.

11. The non-transitory computer-readable medium of claim 8, wherein said performance envelope comprises:
one or more automatically and dynamically developed value ranges indicative of a normal behavior for one or more process attributes selected from a group consisting of: activities, usage, results, and queries.

12. The non-transitory computer-readable medium of claim 8, wherein said performance envelope comprises:
one or more automatically and dynamically developed thresholds for one or more process attributes selected from a group consisting of: activities, usage, results, and queries; and
one or more automatically and dynamically developed value ranges for one or more process attributes selected from said group consisting of: activities, usage, results, and queries.

13. The non-transitory computer-readable medium of claim 8, further comprising:
one or more instructions which, when executed by one or more processors, cause one or more processors to:
analyze said alert for one of said identified data points;
determine if a remediation is needed for said alert based on said analysis of said alert; and
provide, as said response, a no remediation performed message if no remediation is needed.

14. The non-transitory computer-readable medium of claim 8, further comprising:
one or more instructions which, when executed by one or more processors, cause one or more processors to:
analyze said alert for one of said identified data points;
determine if a remediation is needed for said alert based on said analysis of said alert;
perform said remediation if a remediation is needed; and
provide, as said response, a report of said remediation performed.

15. A computer system comprising:
a memory;
a display; and
at least one processor, said at least one processor configured to:
select at least one process;
identify a plurality of metrics for said at least one process;
automatically calculate a performance envelope for at least one of said plurality of metrics;
continually monitor, in real-time, data related to said at least one process for any data related to said plurality of metrics;
automatically store any of said data related to said plurality of metrics in an alert database;
automatically analyze said stored data for any data points outside of said performance envelope for said at least one of said plurality of metrics;
automatically generate an alert for one or more identified data points;
receive a response for each of said identified data points; and
update, in said alert database, said identified data points with said response.

16. The computer system of claim 15, wherein said plurality of metrics are selected from a group consisting of: system performance metrics, key performance indicators (KPIs) metrics, and a combination of said system performance metrics and said KPI metrics.

17. The computer system of claim 15, wherein said performance envelope comprises:
one or more automatically and dynamically developed thresholds indicative of the end of a range of normal behavior for one or more process attributes selected from a group consisting of: activities, usage, results, and queries.

18. The computer system of claim 15, wherein said performance envelope comprises:
one or more automatically and dynamically developed value ranges indicative of a normal behavior for one or more process attributes selected from a group consisting of:
activities, usage, results, and queries.

19. The computer system of claim 15, wherein said alert comprises:
a direct alert automatically provided directly to a client, the direct alert selected from a group consisting of: an email, a text, a message, and a pop-up type alert.

20. The computer system of claim 15, wherein said alert comprises:
a summarizing alert automatically provided to an interactive dashboard application.
